(19) United States
(12) Patent Application Publication
(10) Pub. No.: US 2005/0070196 A1
(43) Pub. Date: Mar. 31, 2005

(54) Protecting electro-optical devices with a fluoropolymer

(76) Inventors: Frank J. Colombo, Rochester, NY (US); Jayesh C. Shah, Odenton, MD (US); Steven P. Pendlebury, Richmond, VA (US)

Correspondence Address: Honeywell International Inc.;Virginia Szigeti, Esq., 15801 Woods Edge Road, Colonial Heights, VA, 23834, US

(21) Appl. No.: 10/920,519

(22) Filed: Aug. 18, 2004

Related U.S. Application Data
(60) Provisional application No. 60/507,393, filed on Sep. 29, 2003.

(51) Int. Cl. H05B 33/04; H05B 33/10

(52) U.S. Cl. 445/25; 313/512

(57) ABSTRACT

A method for protecting an electro-optical device includes the steps of providing an electro-optical device including a first electrode, a second electrode, and an emitting layer disposed between the first electrode and the second electrode, where at least one of the electrodes is optically transparent; and sealing at least a portion of the electro-optical device within a casing formed of a fluoropolymer, preferably a polychlorotrifluoroethylene film. Where the electro-optical device is provided with at least one wire lead extending from a peripheral portion of the electro-optical device, the method includes the step of protecting the wire lead from detrimental environmental conditions using a fluoropolymer. An environmentally sealed electro-optical device is also provided, including an electro-optical device and a fluoropolymer, preferably a polychlorotrifluoroethylene film, protecting at least a portion of the electro-optical device.

This application claims priority of U.S. provisional application Ser. No. 60/507,393, filed Sep. 29, 2003.

### BACKGROUND OF THE INVENTION

1. Field of the Invention

The present invention relates generally to electro-optical devices, including particularly organic electroluminescent devices, and more particularly to such devices that are protected from adverse environmental conditions.

2. Description of the Prior Art

In the field of electronic devices, particularly organic light emitting devices, it is known that exposure to moisture, oxygen and other agents may harm or damage the devices. Many electronic devices therefore require protection from detrimental environmental conditions in order to maintain functionality for commercially acceptable periods of time. OLEDs as herein described are in this category of devices.

Organic electroluminescent (EL) devices are a class of electro-optical devices in which light emission is produced in response to an electrical current through the device. The terms “organic light emitting diode”, “organic light emitting display” or “organic light emitting device” (OLED) are commonly used to describe organic electroluminescent devices having a non-linear current-voltage behavior. As used herein, the terms “OLED” and “OLED device” each refers to this class of devices. It is to be understood that the term OLED as used herein refers to all types of devices in this class.

Unlike liquid crystal displays (LCDs), which typically require backlighting and modulate transmitted or reflected light, OLEDs are emissive devices, i.e., intense light is emitted. As a result, OLED displays are brighter, thinner and lighter; require less space and power; offer higher contrast; and are less expensive to manufacture than LCDs. OLED devices also advantageously operate over a broad range of temperatures.

OLEDs function in a similar manner to inorganic light emitting diodes (LEDs) in that light is transmitted through a transparent electrode deposited on a substantially transparent substrate, which is commonly glass, or through a substantially transparent upper electrode. In a single layer arrangement, an OLED typically comprises one (or two) organic layer(s) comprising the emissive region that are deposited sequentially in forming a stack structure and which are disposed between an anode and a cathode. In a multi-layer arrangement, an OLED stack structure typically includes a separate organic emissive layer disposed between a separate electron transport layer and hole transport layer whereby all of the layers are disposed between an anode and a cathode.

In typical devices, the cathode comprises a material with a low work function such that voltage in the range of from about 3 to about 10 volts causes emission of electrons. The anode typically comprises a material with a high work function and is optically transparent so that light originating from the organic emitting layer will be transmitted therethrough. Alternatively, the cathode may be optically transparent so that light emitted from the device can be transmitted therethrough.

By applying voltage with sufficient amplitude and polarity to an OLED, the anode injects positive charge carriers (holes) and the cathode injects negative charge carriers (electrons) which undergo electron-hole pair recombination in an emissive region, radiatively decay, and in so doing, emit a photon. It should be understood by those with skill in the art that radiative decay and non-radiative decay may result in emission, or non-emission, respectively, of a photon.

The emissive layer or region in a multi-layer arrangement is typically an organic light emitting material or a mixture of organic materials in the form of a thin amorphous or crystalline film disposed between the hole transport layer and the electron transport layer which can be made to electroluminesce by applying voltage across the device. In addition to a hole transport layer and electron transport layer, the OLED stack structure may include additional layers, for example, a hole injection layer, an electron blocking layer, a hole blocking layer, and an electron injection layer. Each layer of the multi-layer device is typically optimized to increase the efficiency by which holes and electrons recombine in the emissive region to produce light.

Organic light emitting devices are used in a variety of displays for high performance devices, including: computer displays; monitors; notebooks; television screens; flat panel displays; general lighting elements, including, for example, instrumentation panels used in the automotive, aerospace, military (visual and navigation devices), medical and other industrial applications. OLED are also used as light sources, such as in bulbs, small displays for cellular phones, microdisplays for wearable computers and electronic game applications, view-finders in videocamcorders, and electronic books and newspapers, and other consumer electronics. In addition, a large area display device with low-voltage driving is now possible with OLEDs. Other uses include ink jet printing, bar code tags, digital video cameras, digital versatile disk (DVD) players, personal digital assistants (PDAs), stereos, and other personal products.

Desirable characteristics for an OLED include operational stability, reliability in performance, and an extended lifetime for commercial use. Many of the organic materials employed in electro-optical devices, and in OLEDs in particular, are sensitive to environmental contaminants, including dust and other small particles, oxidation, and humidity or moisture, all of which lead to device degradation. Likewise, many of the metals used as contact electrodes or wire leads may corrode in air or other environments where oxygen is present. Moreover, OLED structures are fragile, and require careful handling to avoid contamination or fracture.

Applicants have come to appreciate that OLEDs and certain other electronic devices should preferably be sealed from detrimental environmental conditions to prevent moisture and oxygen and other contaminants from adversely affecting the functionality of the cathode and other layers of the OLED device. Although substantial progress has been made in the development of OLEDs, there remains a need for protecting the fragile OLED structure from environmental and other detrimental or harmful conditions. Attempts have been made to protect OLEDs and other electrical devices from adverse environmental conditions, yet applicants have discovered that improvements can be made to make such devices having a protective material which is inert, stable and optically transparent. Thus applicants have come to appreciate a need for an encapsulated OLED device that provides protection from the environment and the capability of connecting to other OLED devices while retaining operational stability, reliable performance and extended lifetime.

### SUMMARY OF THE INVENTION

The present invention provides protected electro-optical devices, such as protected organic light emitting devices, and methods for protecting such devices. Preferred method aspects of the present invention include the steps of providing an electro-optical device, preferably an OLED and sealing at least a portion of the electro-optical device within a material or composition comprising, and preferably consisting essentially of, a fluoropolymer. In certain preferred embodiments, the material or composition comprises a film comprised of fluoropolymer. In certain preferred methods, the step of providing an electro-optical device comprises providing a substrate and mounting at least a portion of the electro-optical device thereon. In such embodiments, the substrate preferably is either flexible, such as would be the case when it is formed from one or more flexible polymers, such as polychlorotrifluoroethylene (PCTFE) or polyester, or it is rigid, such as would be the case when it is formed of glass. The substrate preferably has a peripheral portion which extends beyond the edges of certain portions of the electro-optical device for joining with the composition.

The sealing step preferably includes forming a casing comprising at least one fluoropolymer, such as PCTFE. In certain preferred embodiments, the step of forming the casing includes providing a fluoropolymer film configured to have at least one open end and at least one closed end. In these and other preferred embodiments, the sealing step preferably comprises: disposing at least a portion of the electro-optical device within the casing by inserting at least a portion of the device through said at least one open end of the casing; creating a vacuum within at least the portion of the casing containing the device; and substantially closing said at least one open end to protect the device from detrimental environmental conditions. In certain preferred embodiments, the casing is in the form of a pouch. The sealing step in general and the closing step in particular preferably comprises impulse sealing or direct hot bar sealing.

In other preferred embodiments, the sealing step includes disposing a layer or film comprising fluoropolymer onto at least a portion of the electro-optical device, preferably an OLED, and sealingly joining the film or layer to a substrate to form a sealed protective covering. Where a glass substrate is provided, the sealing step preferably includes joining, preferably adhesively joining, at least a portion of said film or layer to the substrate, preferably using an epoxy adhesive.

Where the electro-optical device includes at least one wire lead extending from a peripheral edge of the device, the methods preferably include the step of protecting the wire lead from detrimental environmental conditions. Protecting a wire lead preferably includes the steps of providing a fluoropolymer resin in a liquid state and disposing the fluoropolymer resin about the wire lead. The fluoropolymer resin preferably comprises a polychlorotrifluoroethylene resin.

The device aspects of the present invention provide an electro-optical device, preferably an organic light emitting device, comprising electro-optical components and a composition or material comprising, preferably consisting essentially of, and even more preferably consisting of, a fluoropolymer protecting at least a portion of the electro-optical components. In certain preferred embodiments, the device is mounted on a substrate, which may be flexible or relatively rigid. The device is preferably an OLED and the fluoropolymer is preferably a PCTFE polymer.

### BRIEF DESCRIPTION OF THE DRAWINGS

The description of the invention may be more fully understood when read in conjunction with the FIGURES, including:

FIG. 1a is a cross sectional view of an electro-optical device according to one aspect of the present invention;

FIG. 1b is a cross-sectional view of an electro-optical device according to another aspect of the present invention;

FIG. 2 is a block diagram illustrating an OLED built upon a transparent substrate in semi-assembled form according to an aspect of the invention;

FIG. 3a is a top view illustrating an OLED with wire leads extending therefrom according to an aspect of the invention;

FIG. 3b is a side view illustrating the OLED of FIG. 3a; and

FIG. 4 is a schematic view illustrating a melting device for resin pellets used to protect wire leads extending from an OLED as illustrated in FIGS. 3a and 3b according to an aspect of the invention.

### DETAILED DESCRIPTION OF THE PREFERRED EMBODIMENTS

In the detailed description that follows, identifying numbers used to refer to a particular element or feature in one figure are used, to the extent feasible, in the other figures to refer to like elements or features. Although the preferred embodiments described herein involve, in large part, OLEDs, it is to be understood that the methods and construction of the present invention may be applied to other devices, including other similar electrical devices, including especially those which emit or transmit light, which require optical clarity, and which are relatively sensitive to moisture and/or oxygen, and/or other contaminants or reactants. For the purpose of convenience, such devices are sometimes referred to herein as sensitive electro-optical devices.

The electro-optical devices of the present invention generally include one or more electro-optical components and a fluoropolymer in a protective relationship with at least a portion of the electro-optical components. As will be understood by those skilled in the art, many electro-optical devices have components that are relatively sensitive to environmental conditions, such as might be presented in relatively humid and/or corrosive atmospheres. In preferred embodiments, at least a portion of an electro-optical component that is sensitive to these or other conditions is in a protected relationship with the composition of the present invention. In certain preferred embodiments, all of the components of the electro-optical device will be in a protected relationship with respect to the composition of the present invention. In other embodiments, certain of the components of the electro-optical device are themselves relatively resistant to such adverse conditions and may cooperate with and/or form part of a protective barrier for the sensitive electro-optical components.

As used herein, the term “fluoropolymer” refers to the class of paraffinic polymers that have some or all of the hydrogen replaced by fluorine. Included among the fluoropolymers that are adaptable for use within the broad teachings of the present invention are polytetrafluoroethylene (PTFE), fluorinated ethylene propylene (FEP) copolymer, perfluoroalkoxy (PFA) resin, polychlorotrifluoroethylene (PCTFE), ethylene tetrafluoroethylene (ETFE) and ethylene chlorotrifluoroethylene (ECTFE) copolymer. The fluoropolymer compositions of the present invention, in general, may comprise any effective combination of such polymeric components, including simple mixtures, interpenetrating polymer networks, copolymers (as used herein, the term “copolymers” includes copolymers, terpolymers, graft copolymers, and block copolymers and the like), and the like. Of the copolymers, ECTFE and ETFE are preferred, with PCTFE homopolymer and copolymers being the most preferred fluoropolymer. As used herein, and unless otherwise specifically mentioned, the term “PCTFE” includes homopolymers and copolymers of chlorotrifluoroethylene (CTFE) monomer, such as copolymers with vinylidene fluoride and terpolymers with vinylidene fluoride and tetrafluoroethylene. Where an oxygen barrier is desired in addition to a moisture barrier, PCTFE may be coextruded with an oxygen barrier resin such as a cyclic olefin copolymer, for example, an extrusion grade resin acrylonitrile-methyl acrylate copolymer sold under the trademark BAREX® by BP Chemicals.

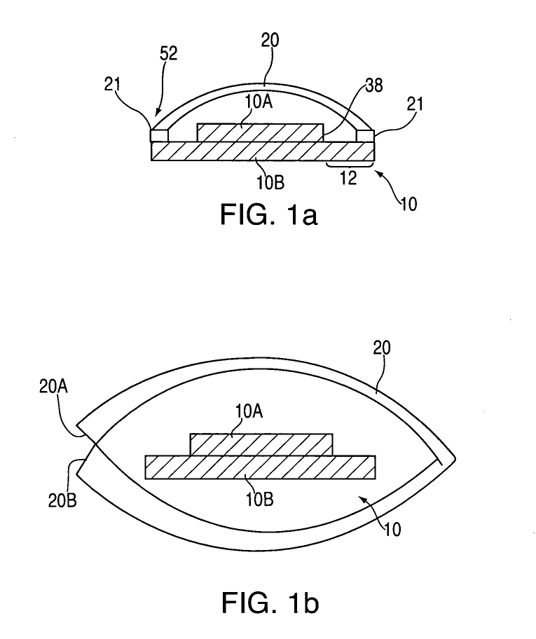

Preferred embodiments of the present invention are illustrated generally in connection with FIG. 1a. According to such embodiments, the present devices comprise electro-optics 10, including at least one sensitive electro-optical component 10A, and a fluoropolymer composition 20 in a protective relationship with at least the sensitive electro-optical component 10A. Although those skilled in the art will appreciate that the particular nature and character of the fluoropolymer composition of the present invention may vary widely within the broad scope hereof, it is generally preferred that the fluoropolymer composition is in the form of a relatively thin film or layer which performs its protective function by at least partially surrounding and/or enclosing and/or encasing the sensitive electro-optical components.

As mentioned herein above, certain electro-optical devices include both sensitive components 10A and non-sensitive components 10B. For such devices, it is possible, although not necessary, that such non-sensitive components 10B of the device 10 participate in the protective function of the present invention, particularly when such non-sensitive components 10B are capable of providing a barrier against the passage of materials which would have a detrimental impact on the performance of the electro-optical device 10 if the sensitive components 10A were to come into substantial contact with such materials. With reference to FIG. 1a, for example, such embodiments comprise the layer 20 being in a sealing relationship with the non-sensitive component 10B. In many preferred embodiments, the non-sensitive component 10B comprises a substrate or support layer upon which the sensitive electro-optical components are mounted, assembled or otherwise disposed. The substrate may be flexible or rigid, depending upon the needs of the particular device. For embodiments in which the substrate is flexible, it preferably comprises a polymeric composition, more preferably a fluoropolymer composition, and even more preferably PCTFE. The substrate is preferably sized so as to have a peripheral portion 12 extending beyond the peripheral edges 38 of the sensitive electro-optic components 10A, as illustrated in FIG. 1a. In such embodiments, the step of sealing comprises disposing the fluoropolymer film or layer 20 onto the device 10 such that the peripheral portions 52 thereof extend beyond the peripheral edges 38 of the device 10; and sealing the peripheral portions 12 of the substrate 10B to the peripheral portions 52 of the fluoropolymer film. In certain preferred embodiments, the fluoropolymer film or layer has peripheral portions 52 which extend at least about ⅛″ (3 mm) beyond the peripheral edges 38 of the sensitive components of the electro-optical components, and even more preferably from about ⅛″ to about ¾″ (about 3 mm to about 19 mm) beyond peripheral edges 38. In such embodiments, it is also generally preferred that the layer 20 has a thickness of about 2 mils to about 15 mils (about 50 to about 375 μm) and that the step of sealing the fluoropolymer layer 20 to the peripheral portions 12 of the substrate 10B comprises impulse sealing and/or direct hot bar sealing, as described in more detail below.

Referring to FIG. 1b, in an alternative embodiment the composition 20 is in a protective relationship with both the sensitive component 10A and non-sensitive component 10B. In the particular configuration illustrated in FIG. 1b, the composition 20 is in the form of a bag, pouch, sleeve or similarly configured thin film of fluoropolymer which has peripheral portions 20A and 20B sealed to one another so as to produce an enclosed, protective environment for the entire electro-optical device 10.

In preferred embodiments of the present invention, the electro-optical device 10 comprises an organic light emitting device (OLED). Those skilled in the art will appreciate that many particular types and arrangements of OLEDs are known and available, and all such types and arrangements are adaptable for use in connection with the present devices in methods. For example, it is to be understood that there may be substantial variations in the type, number, thickness, order, arrangement, and composition of the layers of an OLED device, depending upon the desired application. With regard to total device thickness, the device of the present invention is preferably thin enough to work at low voltage. Suitable dimensions for an OLED depends upon the desired application, whereas in some instances the OLED may be on the micro scale, and whereas in other instances the OLED may be extremely large for use in a display. It is also to be understood that there are numerous materials available for use in OLED devices and in fabrication thereof, and that all such known materials are generally compatible with one or more aspects of the present invention.

Generally, the OLEDs according to an aspect of the invention include a first electrode, a second electrode, and an emitting layer disposed between the first electrode and the second electrode, wherein at least one of the electrodes is optically transparent.

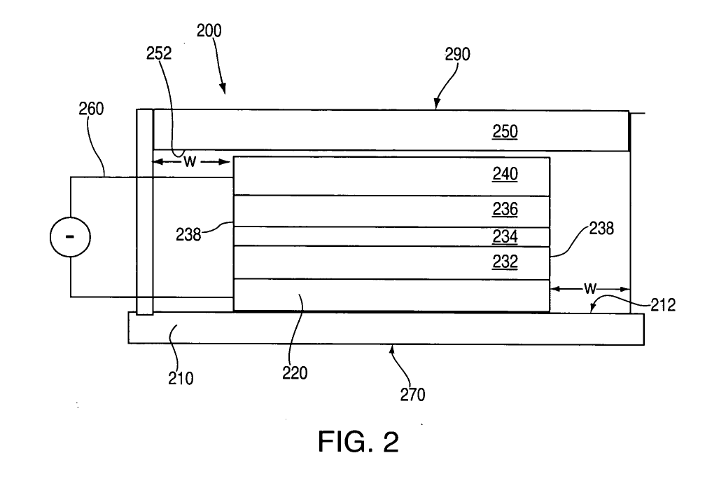

Referring now to FIG. 2, a preferred embodiment of an OLED 200 according to an aspect of the invention is illustrated. In this embodiment, the OLED 200 comprises a relatively non-sensitive barrier component, such as a transparent substrate 210 formed of fluoropolymer, preferably comprising and even more preferably consisting essentially, of a polychlorotrifluoroethylene (PCTFE). Preferred PCTFE homopolymer and copolymer films are commercially available under the trademarks ACLAR® and CLARUS™ from Honeywell International Inc. of Morristown, N.J.

PCTFE homopolymers and copolymers are the preferred materials for use in all embodiments of the present invention, as low permeability to moisture and excellent barrier properties are exhibited. PCTFE is relatively inert to most chemicals and is resistant to high temperatures. PCTFE also generally exhibits a low coefficient of friction. Other advantageous properties of PCTFE include its being lightweight, flexible, clear, easy to use and less expensive than many other currently available flexible protective materials such as flexible glass.

Various grades of PCTFE are known and available, and it is contemplated that all such grades are adaptable for use in connection with the present devices and methods. The films may be of any desired thickness and depending on whether they are oriented or not, their thickness may range from about 0.5 mils to about 15 mils (about 12.5 to about 375 μm), more preferably about 2 mils to about 15 mils (about 50 to about 375 μm), and with about 4 mils to about 6 mils (about 100 to about 150 μm) especially preferred. Advantageously, PCTFE is available in the form of sheets, films or tubes. Other suitable forms of film in accordance with this invention include laminated or coextruded fluoropolymer films. Such films include, for example, adhesively laminated structures of PCTFE homopolymers and copolymers, coextrusions of PCTFE homopolymers and copolymers, PCTFE homopolymers extrusion laminated to PCTFE copolymers, and PCTFE homopolymers extrusion coated with PCTFE copolymers. It should be understood that the reverse structures may also be utilized (e.g., adhesively laminated structures of PCTFE copolymers onto PCTFE homopolymers, etc.). Preferably, the thickness of the PCTFE homopolymer in the above laminated structures would be between about 2 and about 10 mils (about 50 to about 250 μm) and the thickness of the PCTFE copolymer between about 0.3 and about 2 mils (about 7.5 to about 50 μm).

Referring still to FIG. 2, the substrate 210 in this embodiment is flexible, preferably with a thickness of from about 2 mils to about 15 mils (about 50 to about 375 μm). An anode layer 220 is disposed upon the transparent substrate 210 at a suitable thickness using techniques known in the art. According to this embodiment, the anode layer 220 is optically transparent. A hole transport layer (HTL) 232 formed of a suitable material is disposed onto the transparent anode layer 220 at a suitable thickness.

Emitting layer (EML) 234 formed of a suitable material is disposed onto the HTL 232 at a suitable thickness. EML 234 is a region of the OLED in which positive charge carriers (holes) injected by an anode and negative charge carriers (electrons) injected by a cathode recombine, radioactively decay and release energy which is emitted in the form of a photon thereby generating light, commonly referred to as electroluminescence. Electron transport layer (ETL) 236 formed of a suitable material is disposed onto the EML 234 at a suitable thickness, onto which a cathode layer 240 is disposed. Upon application of suitable voltage 260, light is emitted from the region of the EML 234 through transparent anode 220 and transparent substrate 210 through the bottom 270 of the device 200.

Other alternative embodiments of an OLED according to an aspect of the invention include additional layers, i.e., a hole injection layer (HIL), an electron blocking layer (EBL), a hole blocking layer (HBL), and an electron injection layer (EIL), among others. As discussed above, it is to be understood that the number, arrangement, and composition of the individual layers of the OLED 200 may be selectively varied depending upon the desired application.

The particular technique used to form thin-layer films of suitable and chemically compatible compounds for use in an OLED is a function of many parameters, including the desired speed of deposition, temperature, and composition of active chemical components. Various methods for deposition of compounds for use in OLED fabrication are known and are available for use in connection with the present invention. Such methods include electron beam deposition, radio-frequency sputtering, thermal vapor deposition, spin coating, solvent casting, and organic vapor phase deposition (OVPD), and pulsed laser deposition, among others.

Referring still to FIG. 2, a protective layer 250 composed of glass, metal or plastic is disposed adjacent the cathode layer 240 to protect against oxidation and/or moisture. The protective layer 250 is secured to the cathode layer 240 with a suitable adhesive, for example, an epoxy resin.

The substrate 210 includes peripheral portions 212, which extend a distance or width “W” of about ⅛″ to about ¾″ (about 3 mm to about 19 mm) from the peripheral edges 238 of the sensitive electro-optical components, namely the cathode 240, the anode 220 and the layers disposed there between. In this embodiment, portion 212 is sealingly bonded to the peripheral portion 252 of protective layer 250 to form a seal. In certain preferred embodiments, the formation of the seal includes the application of epoxy to one or both peripheral portions. Preferably, the protective layer 250 is formed of PCTFE. Where PCTFE is used as both a substrate 210 and a protective layer 250, the substrate 210 and protective layer 250 are preferably joined together using direct hot bar sealing or impulse sealing as will be described herein.

A seal area of between ⅛″ and ¾″ (about 3 mm to about 19 mm) is thus created about the peripheral edges 238 of the OLED 200, and provides a barrier from environmental conditions for the top 290, bottom 270 and peripheral edges 238 of the OLED 200.

In an alternative preferred embodiment according to an aspect of the invention, the substrate 210 is rigid and formed of glass or opaque plastic. The anode layer 220, HTL 232, EML 234, and ETL 236 are disposed as described previously. In this embodiment, the cathode 240 and protective layer 250 are transparent to permit the passage of light through the top 290 of the OLED 200. The protective layer 250 is preferably formed of PCTFE and is disposed in an environment free of dust and moisture onto the upper surface of the transparent cathode 240 for protecting the cathode layer 240 from degradation and or contamination due to moisture and/or oxygen. If a barrier to oxygen is desired, the protective layer 250 should preferably be formed of PCTFE coextruded with an oxygen barrier polymer, such as a cyclic olefin copolymer (e.g., BAREX® as mentioned above).

Although a coating sold under the trademark BARIX® used alone, or in the manufacture of flexible glass, and available from Vitex Systems, Inc. of San Jose, Calif. may be used as a protective layer for electronic devices such as OLEDs, a PCTFE polymer encapsulant layer 250 according to the invention advantageously provides an overall thinner coating to the OLED structure 200. Use of a PCTFE polymer encapsulant in providing protection to electronic devices is also less expensive than flexible glass, and provides a stable, inert, and optically transparent viable alternative.

In this preferred embodiment, the PCTFE polymer encapsulant layer 250 is affixed to the top of the OLED display system by sealing the peripheral portion 252 of the encapsulant layer 250 to the peripheral portion 212 of the substrate 210 using epoxy. The coupling of the peripheral portions 212 and 252 form a seal. The PCTFE encapsulant layer 250 thus serves as a barrier to moisture, and also serves as the layer through which images are viewed due to its optical clarity.

In an alternative preferred embodiment according to an aspect of the invention, the transparent substrate 210 is flexible and formed of PCTFE. The substrate 210 according to this embodiment preferably has a thickness of from about 2 mils to about 15 mils (about 50 to about 375 μm). The anode layer 220 disposed upon the transparent substrate 210 according to this embodiment is optically transparent. The HTL 232, EML 234, ETL 236, cathode 240 and protective layer 250 are disposed as described previously. In this preferred embodiment, the anode 220 is transparent to permit the passage of light through the bottom 270 of the OLED 200. Upon application of suitable voltage 260, light is emitted from the region of the EML 234 through transparent anode 220 and transparent substrate 210.

An encapsulant layer 250 formed of PCTFE is disposed onto the upper surface of the cathode 340. As described previously, the encapsulant layer 250 and substrate 210 include peripheral portions 212 and 252, respectively for providing a bonding surface for coupling layers 210 and 250 to one another.

According to this alternative preferred embodiment, portion 212 and portion 252 are bonded together using direct hot bar sealing or impulse sealing. According to this aspect of the invention, the sealing of portion 212 to portion 252 forms a substantially uniform barrier to external environmental conditions without the need for epoxy or other adhesive. Prior to the present invention, materials capable of being sealed together and used in protecting devices were not optically pure and imparted haziness, leading to undesirable optical properties affecting images viewed through these materials. The use of PCTFE as a preferred material in this embodiment not only provides excellent clarity through which images may be viewed, but is also an inexpensive alternative. By creating the substrate 210 out of the same material (PCTFE) as the protective layer 250, the substrate 210 and protective layer 250 are sealed together thereby eliminating the need for epoxy sealants, and a substantially uniform barrier is provided in all directions, i.e., top 290, bottom 270, and edges 238 of the device.

An alternative preferred embodiment of according to an aspect of the invention is illustrated also in FIG. 2 in conjunction with FIG. 1b. In this embodiment, an optically transparent substrate 210 is formed of a plastic. A preferred substrate 210 for use in this embodiment is a flexible polyester film. An anode layer 220 is disposed onto the substrate 210, onto which a HTL 232, an EML 234, an HTL 236 and cathode layer 240 are disposed as described previously. Voltage 260 applied across the OLED 200 permits light to be emitted from the region of the EML 234 through transparent anode 220 and transparent substrate 210. Alternatively, the cathode layer 240 may be transparent through which light is emitted.

In this embodiment, the OLED 200 is positioned within a suitably dimensioned casing 20 (FIG. 1b) formed of a fluoropolymer for receiving the OLED 200. A vacuum is created to evacuate air present within the casing 270. Thereafter, the casing 20 is sealed from the outside environment. An OLED 200 sealed within the casing 20 thus is provided with a substantially uniform barrier from moisture intrusion in addition to oxygen intrusion where the casing 270 is formed of PCTFE coextruded with, for example, an acrylonitrile-methyl acrylate copolymer.

The casing 20 may take the form of a pouch or alternatively, may take the form of a tube. Where the casing 20 is in the form of a pouch, one edge needs to be sealed whereas when the casing 20 is in a tube form, at least two edges need to be sealed to the external environment. A preferred fluoropolymer for forming the casing 20 is PCTFE. Advantageously, the substantially uniform barrier provided by the casing 20 is substantially clear and optically transparent to allow transmission of light through the bottom 270 of the OLED 200 and the display of images visible to an observer.

According to this aspect of the invention, the sealing of the casing 20 formed of PCTFE is accomplished without the need for epoxy or other adhesive. Using the technique of direct hot bar or impulse sealing to provide a sealed protective layer for the OLED 200, the casing 20 provides a seal from external environmental conditions.

Impulse sealing is known to those skilled in the art, and is a heating process that does not provide constant heat. To obtaining a suitable seal using the process solely depends upon the duration of the impulse and does not depend upon the application of heat. When using impulse sealing, a seal time of approximately 1.5 seconds is preferably used. The duration of the impulse or current provides the means for sealing the fluoropolymer. The resulting seal formed is substantially smooth and uniform. A suitable impulse sealing device for use with the present invention is available from Packaging Aids Corporation (formerly Vertrod, Inc.) of San Rafael, Calif.

An alternative preferred method for sealing an OLED device within the casing 20 is direct hot bar. In contrast to impulse sealing, direct hot bar provides a constant heat source. The temperature of the heat source should at least reach (and may exceed) the melting point of the fluoropolymer to form a seal. There is no set time period for forming a seal using a direct hot bar technique. A suitable time is about 0.5 to about 2 seconds. If the duration of the heating process, however, is for an extended period of time, the polymer may become brittle and subject to fracture.

Regardless of whether impulse sealing or direct hot bar sealing techniques are used in forming an interface seal of the fluoropolymer layers, the resulting seal provides a substantially uniform barrier in all directions, since the material used in forming the casing 20 is sealed together without the need for epoxy adhesive. This provides a cost and time saving advantage to a manufacturer, as it reduces steps in the manufacturing process. Of these techniques, however, impulse sealing is preferred.

Depending upon the desired application, an advantage to using a flexible substrate formed of a fluoropolymer or polyester allows a display to be folded or rolled up into a more convenient portable form, which in turn leads to ease in transportation and storage. Use of a fluoropolymer as a means for providing a barrier to environmental conditions as opposed to materials such as flexible glass also reduces the chances of surface cracks and provides potential to form tight roll radii while reducing the thickness of an encapsulated device. It should be understood that the scope of the invention is not limited to OLEDs formed on a flexible substrate, but to all electronic devices for which a flexible substrate is used and which devices require protection from environmental conditions.

Where the organic light emitting device 200 includes at least one wire lead extending from a peripheral edge of the device 200, the method includes the step of protecting the wire lead from detrimental environmental conditions. Protecting a wire lead includes the steps of providing a fluoropolymer resin in a liquid state; and disposing the fluoropolymer resin about a wire lead. The fluoropolymer resin preferably comprises a PCTFE polymer.

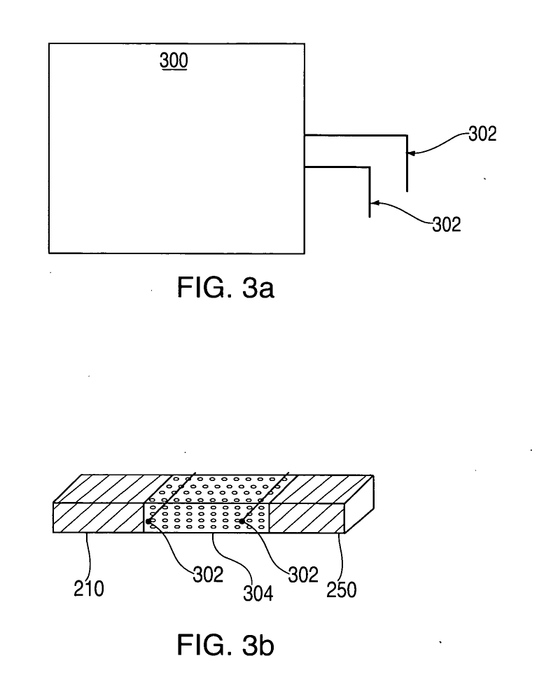

Referring to FIG. 3a, a top view of an OLED 300 illustrates wire leads 302 extending from the OLED 300 for connecting to other OLED devices or to a power source. Referring to FIG. 3b, a side view of the OLED 300 of FIG. 3a illustrates the wire leads 302 in an unprotected region of the OLED 300 with liquid resin 304 disposed within the unprotected region. A preferred resin is ACLON™ PCTFE resin available from Honeywell International Inc. The dimensions of this particular OLED 300 is about 4 to about 8 mils (about 100 to about 200 μm) by about ⅜ inches (about 8 mm ) for purposes of illustration only, as the size varies depending upon the desired application. Illustrated also is the protective layer 250 and substrate 210 of the device 300.

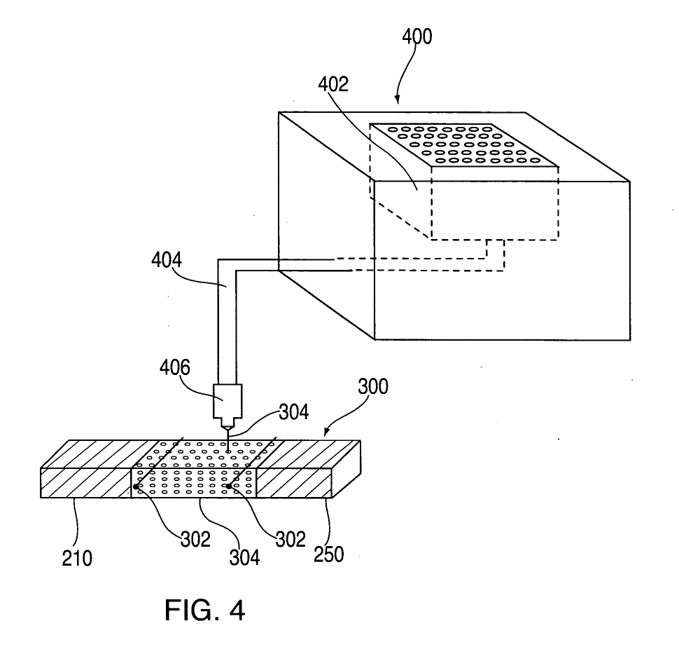

Referring to FIG. 4, a schematic view of a melting device 400 is illustrated. The melting device 400 contains a reservoir 402 and a dispensing device 404 including a dispensing hose 406 for dispensing liquid resin 304 to the unprotected region of the OLED 300. Upon application of the liquid resin 304 to the OLED 300 and thereafter by cooling of the resin to a solid form, the wire leads 302 are protected from environmental conditions.

Sealing of the wire leads 302 with ACLON™ PCTFE resin is preferred as moisture and other environmental conditions may adversely affect the leads 302 and cause the OLED 300 to short-circuit. Moreover, the use of ACLON™ PCTFE resin, which is the same resin as used in ACLAR® film, provides an excellent interface as the two materials are inherently compatible.

The fluoropolymer films (including multilayer films) useful in this invention may optionally be stretched or oriented in any direction by methods known to those skilled in the art. For example, PCTFE films may oriented monoaxially or biaxially. In such a stretching operation, the film may be stretched in either the direction coincident with the direction of movement of the film being withdrawn from the casting roll, also referred to in the an as the “machine direction”, i.e. the direction which is perpendicular to the machine direction, and referred to in the art as the “transverse direction” where the resulting film is “uniaxially” oriented; or the machine direction as well as in the transverse direction, where the resulting film is “biaxially” oriented. Typically, the films may be stretched preferably at draw ratios of from about 1.5:1 to about 10:1, and preferably at a draw ratio of from about 1.5:1 to about 4:1. The term “draw ratio” as used herein indicates the increase of dimension in the direction of the draw. Therefore, a film having a draw ratio of 2:1 has its length doubled during the drawing process. Generally, the film is drawn by passing it over a series of preheating and heating rolls. The heated film moves through a set of nip rolls downstream at a faster rate than the film entering the nip rolls at an upstream location. The change of rate is compensated for by stretching in the film. The films useful in this invention may be monoaxially oriented by known techniques, or biaxially oriented using blown tube apparatus, a double-bubble process or a tenter frame apparatus, and may either be sequentially or simultaneously oriented biaxially.

Although the invention has been described with regard to the preferred embodiments, the details of the description are not to be construed as a limitation thereof. Various embodiments, changes, modifications, and equivalent substitutions may be made without departing from the spirit and scope thereof, which is defined solely by the appended claims.

1. A method for protecting an electro-optical device, comprising:
providing an electro-optical device comprising a first electrode, a second electrode, and an emitting layer disposed between said first electrode and said second electrode, at least one of said electrodes being optically transparent; and
sealing at least a portion of said electro-optical device within a casing comprising a fluoropolymer.

2. The method according to claim 1 wherein said casing comprises polychlorotrifluoroethylene.

3. The method according to claim 2 wherein said casing comprises polychlorotrifluoroethylene film.

4. The method according to claim 3 wherein said polychlorotrifluoroethylene film is oriented.

5. The method according to claim 1 wherein said step of providing an electro-optical device comprises providing a substrate and mounting at least a portion of said electro-optical device on said substrate.

6. The method according to claim 5 wherein said substrate comprises a flexible substrate.

7. The method according to claim 5 wherein said substrate comprises a fluoropolymer.

8. The method according to claim 7 wherein said substrate comprises a polychlorotrifluoroethylene film.

9. The method according to claim 5 wherein said substrate comprises a glass substrate.

10. The method according to claim 5 wherein said substrate comprises a polyester.

11. The method according to claim 5 wherein said casing comprises a fluoropolymer film and said sealing step comprises:
disposing a layer of said fluoropolymer film onto at least a portion of said electro-optical device; and,
sealingly joining said film to said substrate to form a sealed protective layer.

12. The method according to claim 11 wherein said sealing step comprises using epoxy adhesive to seal said fluoropolymer film to said substrate

13. The method according to claim I wherein casing comprises a fluoropolymer film comprising at least one open end and at least one closed end, and wherein said sealing step comprises:
(i) disposing at least a portion of said electro-optical device within said casing by inserting at least said portion of said device through said at least one open end of said casing;
(ii) creating a vacuum within said casing; and
(iii) substantially closing said at least one open end to protect said electro-optical device from detrimental environmental conditions.

14. The method according to claim 13 wherein said casing is in the form of a pouch.

15. The method according to claim 14 wherein said casing comprises polychlorotrifluoroethylene film.

16. The method according to claim 15 wherein said polychlorotrifluoroethylene film is oriented.

17. The method according to claim 15 wherein said closing step comprises impulse sealing said open end of said casing.

18. The method according to claim 15 wherein said closing step comprises direct hot bar sealing said open end of said casing.

19. The method according to claim 5 wherein said substrate has a peripheral portion extending beyond the peripheral edges of said first electrode or said second electrode.

20. The method according to claim 19 wherein said casing comprises a fluoropolymer film and wherein said sealing step comprises the steps of:
disposing said fluoropolymer film onto said electro-optical device such that the peripheral portion of said film extends beyond the peripheral edges of said first or second electrode; and
sealing said peripheral edges of said substrate to said peripheral edges of said fluoropolymer film.

21. The method according to claim 20 wherein said fluoropolymer film comprises polychlorotrifluoroethylene film.

22. The method according to claim 21 wherein said peripheral edges of said polychlorotrifluoroethylene film extend beyond the peripheral edges of said first or second electrode by at least about ⅛″ (about 3 mm).

23. The method according to claim 20 wherein the step of sealing comprises impulse sealing.

24. The method according to claim 20 wherein said sealing step comprises direct hot bar sealing.

25. The method according to claim 1 wherein said electro-optical device comprises at least one wire lead which extends from a peripheral portion of said electro-optical device and further comprises protecting said wire lead from detrimental environmental conditions.

26. The method according to claim 25 wherein the step of protecting said wire lead comprises:
providing a fluoropolymer resin in a liquid state; and
disposing said fluoropolymer resin about said wire lead.

27. The method according to claim 26 wherein said fluoropolymer resin comprises polychlorotrifluoroethylene resin.

29. The method according to claim 1, wherein said electro-optical device is an OLED.

30. The method according to claim 3 wherein said step of forming a casing comprises coextruding said polychlorotrifluoroethylene with a cyclic olefin copolymer.

31. The method according to claim 3 wherein said film is a multilayer structure of a polychlorotrifluoroethylene homopolymer and a polychlorotrifluoroethylene copolymer.

32. An environmentally sealed electro-optical device comprising an electro-optical device and a fluoropolymer protecting at least a portion of said electro-optical device.

33. The device according to claim 32 wherein said device comprises a first electrode, a second electrode, and an emitting layer disposed between said first electrode and said second electrode, at least one of said electrodes being optically transparent.

34. The device according to claim 33 wherein said fluoropolymer comprises a fluoropolymer film.

35. The device according to claim 34 wherein said fluoropolymer film comprises polychlorotrifluoroethylene.

36. The device according to claim 34 wherein said electro-optical device is mounted on a flexible substrate.

37. The device according to claim 36 wherein said substrate comprises polychlorotrifluoroethylene.

38. The device according to claim 35 wherein said electro-optical device is mounted on glass.

39. The device according to claim 34 wherein said film substantially encloses said electro-optical device.

40. The device according to claim 34 wherein said electro-optical device comprises a substrate and said film is sealed to said substrate.

41. The device according to claim 35 wherein said film is a multilayer structure of a polychlorotrifluoroethylene homopolymer and a polychlorotrifluoroethylene copolymer.

42. The device according to claim 35 wherein said film is a coextrusion of polychlorotrifluoroethylene with a cyclic olefin copolymer.

43. The device according to claim 35 wherein said film is oriented.

44. The device according to claim 32 wherein said electro-optical device is mounted on a substrate, said substrate having a peripheral portion extending beyond the peripheral edges of said first electrode or said second electrode.

45. The device according to claim 32, wherein said electro-optical device is an OLED.
